(19) United States
(12) Patent Application Publication
(10) Pub. No.: US 2018/0235262 A1
(43) Pub. Date: Aug. 23, 2018

(54) Preparation Process of High-Quality Apple Jam

(71) Applicant: Jiangnan University, Wuxi (CN)

(72) Inventors: Zhengwei CUI, Wuxi (CN); Jianfeng YU, Wuxi (CN); Haiying CHEN, Wuxi (CN); Jie CUI, Wuxi (CN)

(73) Assignee: Jiangnan University, Wuxi (CN)

(21) Appl. No.: 15/553,178

(22) PCT Filed: Jul. 25, 2016
(86) PCT No.: PCT/CN2016/091541

§ 371 Date: Aug. 24, 2017

(51) Int. Cl. A23L 21/12; A23L 21/15

(52) U.S. Cl. CPC A23L 21/12; A23L 21/15

(57) ABSTRACT

The present invention relates to a preparation method of high-quality apple jam. The preparation method integrates crushing, pulping and steam enzyme deactivation, and immediately adopts ultra-fast cooling after pulping and enzyme deactivation. The ultra-fast cooling integrates vacuum cooling and chilled brine conduction cooling. The whole technological process features strict control over parameters, retention of the original color, luster, flavor and nutrients. The present invention includes the following procedures: quality control of raw materials, namely apples, combination of crushing, pulping and steam enzyme deactivation, ultra-fast cooling, filtration, separation, multi-effect low-temperature concentration, formulating, canning, sterilization and fast cooling. The preparation process of the present invention not only greatly reduces the enzymatic browning of the polyphenol oxidase, but also effectively avoids losses of its flavor and nutrients such as sugar, proteins, mineral substances and etc., obtaining high-quality apple jam with excellent color, and taste and therefore having a huge market promotion value.

### CROSS REFERENCE TO RELATED APPLICATIONS

This application is the national phase entry of International Application No. PCT/CN2016/091541, filed on Jul. 25, 2016, the entire contents of which are incorporated herein by reference.

### TECHNICAL FIELD OF THE INVENTION

The present invention belongs to the technical field of food processing, and specifically relates to a preparation process of high-quality apple jam which maintains the original color, luster taste, aroma, and nutrients of apples.

### BACKGROUND OF THE INVENTION

A proverb “One apple a day keeps the doctor away” is widely spread in western countries, which means that apples and the processed products thereof have a high nutritive value and a good medical care effect. It is measured that every 100 g of apples include 6.5-11.2 g fructose, 2.5-3.5 g glucose and 1.0-5.2 g sucrose, and includes microelements zinc, calcium, phosphorus, iron, potassium, vitamin B1, vitamin B2, vitamin C, and carotene, pectin, cellulose, etc. Scientific research achievements show that the pectin and tannic acid in apples have astringency and can expel toxins and wastes in the intestinal tract, while organic acids can stimulate intestinal walls and increase intestinal motility; carbohydrates in apples are mainly comprised of sugars, and the sugars are easily converted into glucose and fructose which are easily absorbed by human bodies; apples are rich in soluble phosphorus and iron, aiding digestion and absorption of infants; and apples also have medical care functions of moistening the lungs, making people feel happy, promoting the secretion of saliva, stimulating appetite, quenching thirst, relieving summer-heat, harmonizing spleens, stopping diarrhea, neutralizing excessive gastric acid and promoting the secretion of epinephrine. Eating apples regularly can also improve the respiration system and the lung functions. Medical research also shows that apples have a radiation protection function. The combination of flavonoid compounds in apples and polyphenols compounds can restrain the growth and diffusion of cancer cells in human bodies, so apples have an anti-cancer effect. It can be seen that apples have a very high nutritive value.

China ranks first in apple yield in the world, with an annual yield of about 46 million tons in 2106, accounting for over 50% of the total apple yield in the world. However, 1.5 million tons of apples are output each year, which only accounts for 1-2% of the global apple output; 8 million tons of fresh apples are made into apple juices, canned apples, and dehydrated products; over 23 million tons of apples are consumed as fresh fruits in the domestic market. A lot of pressures are imposed on the sales and price of apple, and the income of apple farmers is seriously affected. Meanwhile, during apple processing, polyphenols oxidase contacts primers once the apples are crushed, and then an enzymatic browning reaction is triggered immediately, which brings huge difficulties to the processing and utilization of apples and to the apple product development. Substantial breakthroughs and progress for solving such problems have still not been found in China and even around the world.

At present, the main production process of the apple jam in the prior art is cooking in water, for example the patent CN201310488960.2 and the patent CN201310633176.6 both employ such production process. When cooked in water, apples are heated for a long time, seriously damaging the original taste and active ingredients of apples. Nutrients such as sugars, proteins, mineral substances and vitamins are seriously lost during the water cooking process. The patent CN201310488960.2 employs the way of pre-cooking apple dices or slices with steam, adding 0.2% citric acid into the pre-cooking liquid in advance to maintain the color, pulping and concentrating the pre-cooked substance. Such method retains the nutrients of the raw materials, but due to long heating time during the apple processing, the apple taste is still seriously affected.

Through researches and studies on the existing patents and journal articles, it is easily found that the majority of the literature or research focuses on anti-browning agents for apple products, and usually neglects the enzymatic browning of the pulp which occurs during fruit crushing.

### SUMMARY OF THE INVENTION

Aiming at problems in the prior art, the present invention provides a technology of quickly heating steam to the enzyme deactivation temperature and then performing ultra-fast cooling. The present invention realizes the utilization of a physical method to perform enzyme deactivation and anti-browning treatment on apples that tend to get brown, and conforms to the current green and safe food processing concept. After enzyme deactivation, the pulp is ultra-fast cooled to room temperature, avoiding boiling the pulp, and retaining the original taste and nutrients of apples.

In order to achieve the above objective, the technical solution of the present invention is as follows:

The present invention provides a preparation process of high-quality apple jam, including the following steps:

(1) Raw material selection and pre-treatment: fresh and relatively mature apples without mould, decay, insects and pesticide residues are selected as raw materials with a sugar degree of greater than 12 Brix; the raw materials are washed clean using a bubbling cleaner; every apple is cut into 4-8 sections to facilitate the subsequent crushing, pulping and enzyme deactivation integrated treatment.

(2) Crushing, pulping and enzyme deactivation integrated treatment: the apples treated in step (1) are crushed and pulped, wherein the apples are crushed into particles with a diameter of about 2 mm by using a fast revolving blade tool; the crushing sizes of the particles can be controlled by controlling the edge sharpness, rotating speed and time of the blade tool. Here, it is better that the apples are not crushed to too small of a degree; otherwise, the taste of the product is affected. Besides, kernels are relatively hard and are not crushed as far as possible during the crushing, pulping and enzyme deactivation process. Several minutes before the crushing begins, air in the crushing cavity is exhausted by the steam that is filled in in advance. The steam is uniformly sprayed on the crushed apple particles. Here, the steam spraying pressure is 0.15-0.3 MPa; the steam is input until the pulp temperature quickly rises to 82-92° C. within 1-3 min, and the temperature is kept at 82-92° C. for 42-12 s. In this step, the final temperature after the temperature rise and the maintaining time of the final temperature follow a linear inverse relation: T=−t/3+96, wherein T represents the final temperature, in unit of ° C.; and t represents the maintaining time, in unit of s. During crushing and pulping, vitamin C or citric acid (w/w) which accounts for 0.006-0.05% of the mass of the apple materials can be randomly added, to further conduct the color-protecting function of the vitamin C or citric acid and to play a role of adjusting the acidity of the pulp.

(3) Ultra-fast cooling: the apple pulp obtained in step (2) is quickly cooled by using a way of combining vacuum cooling and chilled brine conduction cooling such that the pulp is quickly cooled to a temperature of below 40° C. within 2-3 min. Specifically, the apple pulp is quickly pumped into a vacuum cooler within 1-2 min such that the pulp descends in a film state; the vacuum cooler is a centrifugal scraper type film evaporator; chilled brine is filled in a jacket of the evaporator; the vacuum degree during vacuum cooling is 0.085-0.1 Mpa, and the temperature of the chilled brine is smaller than −4° C.

(4) Post-treatment: the apple pulp prepared in step (3) is filtered to remove the kernels; the pure pulp is concentrated in a multi-evaporators at a low temperature, formulated, canned, sterilized and cooled, and then finished products are obtained, wherein a screen with an aperture of 2 mm is adopted to filter the apple pulp to remove the apple kernels; a film-descending type four-effect evaporator is adopted to perform the low-temperature concentration, wherein a first-effect temperature is 50-60° C.; a second-effect temperature is 42-50° C.; a third-effect temperature is 35-42° C.; and a fourth-effect temperature is 25-35° C.; after concentration, the content of the soluble solids in the apple jam is 60-75 Brix;

2-8 mass % (w/w) cane sugar or 3-6 mass % (w/w) honey (with a moisture content of about 20% itself) can be added; a proper amount of gelatin, Arabic gum or pectin which is dissolved in advance and has a concentration of 1-5% can be added; and a proper amount of vitamin C or citric acid can also be added to regulate the acidity. The concentrated apple jam is added with the above-mentioned materials, blended, stirred homogeneously, and then canned to obtain finished products;

The obtained finished products are sterilized in a pressure sterilizer; the sterilization temperature in the center of the jam reaches 90-98° C. and is kept for 4-7 min; and the jam is sprayed with cold water after sterilization until the temperature quickly descends to about 30° C.

Preferably, the vacuum cooler used in the ultra-fast cooling process in step (3) has the following structure. Refer to FIG. 1, the vacuum cooler includes a scraper 1, an inner barrel 2, a jacket 3, a distributing round plate 4, a baffle 5 and a motor 6; the inner barrel 2 is cylindrical, wherein the scraper 1 is disposed in the inner barrel 2 and keeps a clearance of 1-3 mm away from the inner barrel 2; the jacket 3 is disposed on the periphery of the inner barrel 2; the distributing round plate 4 is connected to a position above the scraper 1; the motor 6 controls the rotation of the scraper 1, the distributing round plate 4 and the baffle 5; and the vacuum cooler is provided with a vacuuming opening A which is connected with a vacuum pump, a feed port B at a position parallel to the distributing round plate 4, a coolant inlet D below the jacket 3, a coolant outlet C above the jacket 3, and a discharge opening E at the bottom of the inner barrel 2.

In use, the motor 6 of the vacuum cooler drives the scraper 1 and the distributing round plate 4 to rotate under the action of a speed reducer; the pulp is pumped into the feed port B, and descends in a film state along the inner wall of the inner barrel 2 of the vacuum cooler under the action of the distributing round plate 4 and the scraper 1; the vacuuming port A is in a connection with the vacuum pump such that the inner barrel 2 of the vacuum cooler is in the vacuum state, so a part of the moisture in the pulp is quickly evaporated and consumes the latent evaporation heat when the pulp descends in the film state by the gravity effect, thus quickly cooling the pulp; and meanwhile, the jacket 3 is provided with the chilled brine which enters through the coolant inlet D and flows out through the coolant outlet C to speed up pulp cooling and reduce the amount of the moisture evaporated from the pulp, which facilitates the speeding up of the cooling and the improvement of the product quality; and finally, the pulp which undergoes ultra-fast cooling flows out via the discharge opening E, and is collected and delivered to the post-treatment procedure.

Those skilled in the art know that the main enzyme which makes the juice turn brown is polyphenol oxidase. Experimental data shows that the polyphenol oxidase can be completely deactivated when heated for 1 min at a temperature of 80° C. or heated for 15 s at a temperature of 90° C. In the present invention, through numerous experimental studies, it is found that, on the one hand, in the case that the steam is input to deactivate the enzyme when the apples are crushed, if the temperature is controlled to be 82-92° C. and the steam input time is controlled to be 42-12 s, the lower the temperature is, the longer the steam input time is, and the higher the temperature is, the shorter the steam input time is. The final temperature and the maintaining time after the temperature rise follow a linear inverse relation: T=−t/3+96, wherein T represents the final temperature, in unit of ° C.; and t represents the maintaining time, in unit of s. On the other hand, the pulp after enzyme deactivation must be ultra-fast cooled such that the pulp is quickly cooled from nearly 90° C. to normal temperature within 2-3 min, avoiding boiling of the pulp. High-quality apple jam can be prepared only by combining the “crushing, pulping and steam deactivation integration” technology and the “ultra-fast cooling” technology together and by strictly controlling process parameters. To realize fast steam heating and enzyme deactivation, equipment which is specially designed and manufactured is needed, for example the patent CN201510862729.4 applied by the inventor of the present invention, wherein the steam pressure, flow and the feed amount of the materials are required to be adjustable and controllable.

Comparing with the prior art, the present invention has the following beneficial effects:

The present invention realizes enzyme deactivation by using a physical method and invents a green and safe production process of high-quality apple jam. The steam is input during pulping, so the steam can instantaneously heat the crushed materials to the required temperature and maintain the required time. Due to the high efficiency of the combination of crushing, pulping and steam enzyme deactivation, compared with the static treatment of apple dices, the enzyme deactivation is carried out more homogeneously during steam heating, and the temperature rise is faster, so the enzymatic browning can be efficiently restrained to the largest extent, and losses of nutrients such as sugar, proteins, mineral substances and vitamins are completely avoided.

The present invention adopts a way of combining the vacuum cooling and chilled brine conduction cooling technologies together after enzyme deactivation to quickly reduce the temperature. In virtue of the ultra-fast cooling, the materials are prevented from overheating and generating an over-boiled taste, and the polyphenol oxidase in the fruits is deactivated, thus well protecting the color, flavor and nutrients of the finished products, and ensuring the taste of the products. The pulp prepared by combining the crushing, pulping, and steam enzyme deactivation processes is pumped into the distributing round plate, and descends along the inner wall of the inner barrel under the action of the centrifugal force and the gravity force. At this time, the temperature of the material which has just entered the ultra-fast cooler is far greater than the saturation evaporation temperature of water at such vacuum degree, so the moisture in the pulp is quickly evaporated to consume the latent evaporation heat; under the action of the rotating scraper, the pulp descends in a film state such that the moistures evaporated and escapes out without resistance, and then the material temperature drops dramatically. The chilled brine in the jacket takes the pulp heat away from the outer wall of the inner barrel, not only speeding up pulp cooling, but also reducing the vacuum evaporating losses of the flavor ingredients in the pulp, further ensuring the product quality.

Besides, the present invention replaces the conventional cooling and concentrating approach by a low-temperature multi-effect vacuum concentration approach, preventing the apples from being heated for a long time, further retaining the original flavor of the apples.

In conclusion, the present invention adopts the crushing, pulping and steam enzyme deactivation-integrated technology, then performs ultra-fast cooling by combining the vacuum cooling and chilled brine conduction cooling technologies together, strictly controls process parameters and reduces the temperature and time of thermal treatment to the maximum extent at the same time. The present invention realizes enzyme deactivation by using a physical method, greatly retains the original color, nutrients and flavor of the apples, avoids boiling of the pulp, realizes real green and high-quality processing of concentrated apple jam, and provides a reliable guarantee for the preparation of high-quality apple jam. The technical solution provided by the present invention greatly pushes the development of the apple jam process, obviously improves the product quality and optimizes the production process, and has huge economic benefits and social benefits.

### BRIEF DESCRIPTION OF THE DRAWINGS

FIG. 1 is a schematic structural diagram of a vacuum cooler used in a preferred solution of the present invention.

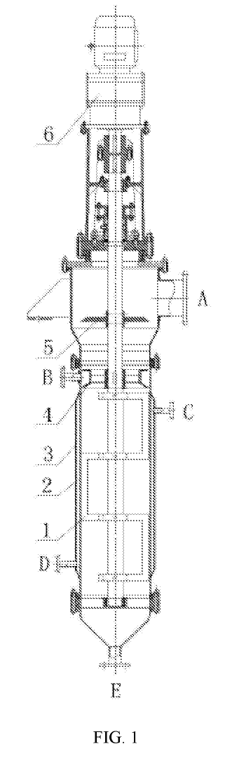

In FIG. 1, 1. scraper; 2. inner barrel; 3. jacket; 4. distributing round plate; 5. baffle; 6. motor; A. vacuuming port; B. feed port; C. coolant outlet; D. coolant inlet; E. discharge opening

### DETAILED DESCRIPTION OF THE INVENTION

The present invention is described in detail below in conjunction with the attached drawings and embodiment. The embodiment, implemented on the premise of the technical solution of the present invention, provides the detailed implementation means and specific operation process on the basis of this technical solution, but the protective scope of the present invention is not limited to the following embodiment.

### Embodiment 1

(1) Raw material selection and treatment: Fresh and relatively mature Fuji apples without mould, decay, insects and pesticide residues are selected as raw materials with a sugar degree of greater than 12 Brix; the raw materials are washed clean;

(2) Cutting: Every apple is cut into 4 sections to facilitate the subsequent crushing, pulping and enzyme deactivation integrated treatment;

(3) Crushing, pulping and enzyme deactivation integrated treatment: During apple crushing, the steam with a pressure of about 0.15 MPa is sprayed onto the apples which are being crushed, such that the pulp temperature quickly rises to 86° C. within 2 min and is kept at 86° C. for 30 s;

(4) Ultra-fast cooling: the pulp obtained after the steam heating type enzyme deactivation and crushing procedures is pumped into a centrifugal scraper type film vacuum evaporator such that the pulp descends in a film state; the jacket of the evaporator is filled with chilled brine, wherein the vacuum degree is 0.092 MPa; the temperature of the chilled brine is −10° C.; finally, the pulp is quickly cooled to room temperature within 2.5 min while being de-gasified;

(5) Filtration: A screen with an aperture of 2 mm is adopted to filter out apple kernels;

(6) Low-temperature concentration: the de-gasified apple pulp is concentrated at a low temperature by using a film-descending type four-effect evaporator, wherein a first-effect temperature is 50° C.; a second-effect temperature is 42° C.; a third-effect temperature is 35° C.; a fourth-effect temperature is 25° C.; after four-effect treatment, the content of the soluble solids in the concentrated apple pulp is 60 Brix (refractometry at a temperature of 20° C.);

(7) Formulating: 5% cane sugar, 1.5% gelatin solution which is prepared in advance and 0.03% vitamin C are added;

(8) Blending and stirring: the materials mixed in step (7) are blended with the concentrated apple pulp obtained in step (6) and the mixture is stirred homogeneously;

(9) Canning: The pulp jam obtained in step (8) is canned to obtain finished products;

(10) Sterilization: A sterilization reactor is adopted to sterilize the finished products; the temperature in the sterilizing center is 98° C.; the sterilization time is 4 min; and the canned jam is quickly cooled to about 35° C. by means of spraying after sterilization.

### Embodiment 2

(1) Raw material selection and treatment: Fresh and relatively mature Fuji apples without mould, decay, insects and pesticide residues are selected as raw materials with a sugar degree of greater than 12 Brix; the raw materials are washed clean;

(2) Cutting: Every apple is cut into 6 sections to facilitate the subsequent crushing, pulping and enzyme deactivation integrated treatment;

(3) Crushing, pulping and enzyme deactivation integrated treatment: During apple crushing, steam with a pressure of about 0.20 MPa is sprayed onto the apples which are being crushed, such that the pulp temperature quickly rises to 90° C. within 1 min and is kept at 90° C. for 18 s;

(4) Ultra-fast cooling: the pulp obtained after the steam heating type enzyme deactivation and crushing procedures is pumped into a centrifugal scraper type film vacuum evaporator such that the pulp descends in a film state; the jacket of the evaporator is filled with chilled brine, wherein the vacuum degree is 0.098 MPa; the temperature of the chilled brine is −6° C.; finally, the pulp is quickly cooled to room temperature within 3 min while being de-gasified;

(5) Filtration: A screen with an aperture of 2 mm is adopted to filter out apple kernels;

(6) Low-temperature concentration: the de-gasified apple pulp is concentrated at a low temperature by using a film-descending type four-effect evaporator, wherein the first-effect temperature is 60° C.; the second-effect temperature is 50° C.; the third-effect temperature is 42° C.; the fourth-effect temperature is 35° C.; after four-effect treatment, the content of the soluble solids in the concentrated apple pulp is 75 Brix (refractometry at a temperature of 20° C.);

(7) Formulating: 4% honey (with a moisture content of about 20%), 5% Arabic gum which is prepared in advance and 0.03% citric acid are added;

(8) Blending and stirring: the materials mixed in step (7) are blended with the concentrated apple pulp obtained in step (6) and the mixture is stirred homogeneously;

(9) Canning: The pulp jam obtained in step (8) is canned to obtain finished products;

(10) Sterilization: A sterilization reactor is adopted to sterilize the finished products; the temperature in the sterilizing center is 92° C.; the sterilization time is 6 min; and the canned jam is quickly cooled to about 35° C. by spraying after sterilization.

### Embodiment 3

(1) Raw material selection and treatment: Fresh and relatively mature Fuji apples without mould, decay, insects and pesticide residues are selected as raw materials with a sugar degree of greater than 12 Brix; the raw materials are washed clean;

(2) Cutting: Every apple is cut into 8 sections to facilitate the subsequent crushing, pulping and enzyme deactivation integrated treatment;

(3) Crushing, pulping and enzyme deactivation integrated treatment: During apple crushing, the steam with a pressure of about 030 MPa is sprayed onto the apples which are being crushed, such that the pulp temperature quickly rises to 82° C. within 1 min and is kept at 82° C. for 42 s;

(4) Ultra-fast cooling: the pulp obtained after the steam heating type enzyme deactivation and crushing procedures is pumped into a centrifugal scraper type film vacuum evaporator such that the pulp descends in a film state; the jacket of the evaporator is filled with chilled brine, wherein the vacuum degree is 0.085 MPa; the temperature of the chilled brine is −8° C.; finally, the pulp is quickly cooled to room temperature within 2 min while being e-gasified;

(5) Filtration: A screen with an aperture of 2 mm is adopted to filter out apple kernels;

(6) Low-temperature concentration: the de-gasified apple pulp is concentrated at a low temperature by using a film-descending type four-effect evaporator, wherein the first-effect temperature is 55° C.; the second-effect temperature is 46° C.; the third-effect temperature is 39° C.; the fourth-effect temperature is 30° C.; after four-effect treatment, the content of the soluble solids in the concentrated apple pulp is 65 Brix (refractometry at a temperature of 20° C.);

(7) Formulating: 7% (w/w) of cane sugar, a proper amount of 1.5% (w/w) gelatin solution prepared in advance and 0.03% (w/w) vitamin C are added;

(8) Blending and stirring: the materials mixed in step (7) are blended with the concentrated apple pulp obtained in step (6) and the mixture is stirred homogeneously;

(9) Canning: The pulp jam obtained in step (8) is canned to obtain finished products;

(10) Sterilization: A sterilization reactor is adopted to sterilize the finished products; the temperature in the sterilizing center is 90° C.; the sterilization time is 7 min; and the canned jam is quickly cooled to about 35° C. by spraying after sterilization.

By adopting the basic technical solution of embodiment 2 and changing some of the steps, contrast examples 1-4 are obtained as below:

In contrast example 1, the pulping operation in step (3) and in step (4) of embodiment 2 is changed to natural pulping by using a pulping machine;

In contrast example 2, the pulping operation in step (3) of embodiment 2 is changed to natural pulping using a pulping machine, and then the pulp quickly undergoes enzyme deactivation at a temperature of 90° C. for 15 s;

In contrast example 3, the pulp in step (4) of embodiment 2 is naturally cooled to room temperature;

In contrast example 4, the pulp in step (4) of embodiment 2 is pumped into a vacuum cooler, and the scraper does not rotate while the vacuum coolers perform vacuuming to cool the pulp to room temperature.

The products obtained in embodiments 1-3 and the products obtained in contrast examples 1-4 were measured, and indices such as sensory assessments, browning and polyphenol content were respectively compared. Below are the details.

(1) The scoring criteria of the sensory assessments can be seen in Table 1. Seven samples were taken from the embodiments 1-3 and the contrast examples 1-4; every sample was divided into five parts; the assessments were carried out three times and the average value was used. The color, smell, taste and general feeling of the apple jam were assessed and scored. The full score is 100 points.

TABLE 1
Sensory assessment scoring table of the apple jam

| | | | | | |
|---|---|---|---|---|---|
| Luster | The jam has | The jam has | Has a little | The color is | The product |
| | attractive | the natural | color of the | inappropriate, | luster is |
| | natural luster | luster of the | jam, but the | but does not | mixed or the |
| | of the jam | jam, but the | visual effect | affect the | luster is |
| | (25-21 points) | luster is not | is not obvious | product | unpleasant |
| | | obvious | (15-11 points) | appearance | (5-1 points) |
| | | (20-16 points) | | (10-6 points) | |
| Smell | The jam has a | The jam has | The jam has | The jam has | The jam does |
| | strong apple | an apple | an apple | an aroma | not have a |
| | smell which | smell which | smell which | which is | jam aroma, |
| | matches the | matches the | matches with | similar to the | and but has a |
| | unique aroma | unique aroma | the unique | apple aroma, | strongly |
| | of the apple | of the apple | aroma of the | but also has a | terrible smell |
| | jam, and has a | jam, and the | apple jam, but | little terrible | (5-1) |
| | full aroma | aroma is soft | the aroma is | smell (10-6 | |
| | (25-21 points) | but slight | not soft | points) | |
| | | (20-16 points) | (15-11 points) | | |
| Taste | The jam has a | The jam has | The jam has | The jam has a | Incorrect |
| | strong apple | an apple jam | an apple jam | little apple | flavor, |
| | jam taste | taste which is | taste which is | jam taste | terrible taste |
| | (25-21 points) | soft (20-16 | not | which is too | (5-1 point) |
| | | points) | homogeneous | light to | |
| | | | (15-11 points) | maintain | |
| | | | | (10-6 points) | |
| General | The product | The product | The product | The product | The product |
| assessments | gains an | gains a good | gains a | gains a poor | gains a very |
| | excellent | general | medium | general | bad general |
| | general | assessment | general | assessment | assessment |
| | assessment | result, and is | assessment | result, and is | result, and is |
| | result, and is | relatively | result and is | relatively | rejected (5-1 |
| | very popular | popular | generally | unpopular | points) |
| | (25-21 points) | (20-16 points) | popular | (10-6 points) | |
| | | | (15-11 points) | | |

Apple browning is classified into enzymatic browning and non-enzymatic browning; and the main browning is enzymatic browning, usually completed within 10 min after apples are crushed. The pulp color and the variable value L of the color along with the time are measured, and different treatment methods are employed to determine and compare the luster of the apple pulp. The larger the value L is, the brighter the pulp is; vice versa. The anti-browning effect of sodium metabisulfite is good, so apple pulp added with 2% (w/w) sodium metabisulfite is used as a standard sample.

During the determination of the value L, a HunterLab (model UltraScanPro1166, American company HunterLab) colorimeter is usually used to determine the juice color, and the data results are represented by L, a and b. A standard white board is used to carry out verification first. Then, a cylindrical sample machine (58 mm diameter and 15 mm depth) containing pulp of the same mass is placed under the aperture (50 mm diameter) of the colorimeter, wherein L is called brightness index. L=0 represents black, L=100 represents white; wherein a and −a respectively represent red and green, the larger the absolute value of a is, the more the colors respectively approach pure red and pure green, the color is grey when a=0; wherein b and −b respectively represents yellow and blue, the larger the absolute value of b is, the more the colors respectively approach pure yellow and pure blue, and the color is gray when b=0.

$$Relative browning rate = \frac{{L}_{control} - {L}_{sample}}{{L}_{control} - {L}_{nature}}$$

L_{control}—Value L (which basically does not change along with time) of the pulp generated after the apples added with 2% sodium metabisulfite are crushed and pulped;

Lₙₐₜᵤᵣₑ—Value of the apple pulp kept for 10 min after the apples are naturally crushed and pulped;

Lₛₐₘₚₗₑ—Value L of the apple pulp after the apple pulp prepared in embodiments 1-3 and contrast examples 1-4 is placed for 10 min.

(3) Polyphenols are substances which determine the flavor and color of apples and apple products, having a close relationship with the sensory qualities of apples and products thereof. Apple polyphenols mainly include catechinic acids, proanthocyanidins, hydroxycinnamic acids, dihydrochalcone, flavonol and anthocyanin types.

Folin-reagent method for determination of the total amount of polyphenols: (1) Standard curve making: 100 μg/mL 0.05, 0.10, 0.15, 0.20, 0.25 and 0.30 mL of gallic acid standard solutions are respectively accurately absorbed and placed in 5 mL volumetric flasks; 1.95, 1.90, 1.85, 1.80, 1.75 and 1.70 mL of distilled water is respectively added into the corresponding volumetric flasks, and followed by 1.0 mL of folin reagent; the mixed materials are fully shaken and then kept still for 3-4 min; 1.0 ml of 10% Na₂CO₃ solution is respectively added into the volumetric flasks; and the mixtures are fully shaken and placed in a constant-temperature water-bath and react for 7 h. Meanwhile, a control group without reagent is made; absorbency is determined at a bandwidth of 765 nm; and linear regression of the absorbancy is carried out by using the content to obtain a regression equation. (2) Raw material treatment: 5.000 g of apple pulp is accurately weighed and placed in a conical flask; 80 ml of 70% ethanol is added; thermal refluxing extraction carried out three times in an 80° C. water-bath, 2 h each time; the mixture is centrifuged for 20 min at a speed of 4,000 r/min; the supernate is collected and merged; the emerged supernate is concentrated in a rotary evaporator at a pressure of 0.09 MPa while ethanol is recycled; and the concentrated solution is added with distilled water to fix the volume to 50 mL, and the prepared solution is kept for later determination.

Determination principle and method: polyphenol compound molecules have hydroxy which is very easily oxidized, and reacts with the Folin-Ciocalten reagent in alkaline conditions; the reaction product is blue, and has the maximum absorbency at the bandwidth of 765 nm; the reaction product follows the Lambert-beer's law in certain conditions; the total amount of the apple polyphenols can be determined by using gallic acid as a reference substance. According to such determination principle, 2 mL of the solution is absorbed from the 50 mL of solution to be determined; the absorbency is determined by using the standard curve making method; the polyphenol content in the 2 mL of solution to be determined is calculated according to the regression equation; and then, the content of the phenolic substances in 1 g of samples is further calculated (based on the gallic acid mg/g, DW).

The above determination results undergo data processing, and the final results are filled in the table 2 below.

TABLE 2
Quality evaluation table of the apple jam prepard by using
different processing methods

| | Relative | | Score of the | Boiled |
|---|---|---|---|---|
| Processing | browning | Retention rate of | sensory | taste or |
| method | rate | total polyphenols | qualities | not |
| Contrast | 100% | 9% | 69.6 | No |
| Example 1 | | | | |
| Contrast | 88% | 22% | 73.1 | Yes |
| Example 2 | | | | |
| Contrast | 3.8% | 92.8% | 75.1 | Yes |
| Example 3 | | | | |
| Contrast | 3.5% | 93.3% | 80.8 | Yes |
| Example 4 | | | | |
| Embodiment 1 | 2.9% | 95.1% | 94.6 | No |
| Embodiment 2 | 2.6% | 95.4% | 95.1 | No |
| Embodiment 3 | 2.5% | 96.1% | 96.5 | No |

In table 2, all raw materials are fresh and mature Fuji apples, and except for a few steps, all other processing links are identical. By analyzing the data in table 2 it can be seen that the traditional processing method in the prior art has the following defects: the pulp obtained using the processing method which includes cold crushing and natural pulping (referring to the contrast example 1) and the pulp obtained using the processing method which includes cold crushing, natural pulping and heating enzyme deactivation (referring to contrast example 2) generate seriously enzymatic browning, obtain the poorest sensory evaluation, and have a very low retention rate of anti-oxidization component, namely polphenols. By using the method of combining crushing, pulping and steam enzyme deactivation, the enzymatic browning is well restrained and the anti-oxidization component, namely polyphenols, is retained to a certain degree, but the natural cooling (referring to the contrast example 3) and the mere vacuuming cooling (referring to the contrast example 4), are not fast enough, and the products have a boiled taste which is difficult to remove after the products are concentrated, so the sensory assessment results are undesirable. Only by adopting the ingenious combination of the crushing and steam enzyme deactivation-integrated method and the ultra-fast cooling method provided by the present invention can the enzymatic browning be well restrained (referring to embodiments 1, 2 and 3), can the anti-oxidization component, namely polyphenols, be retained to be maximum extent, can the products avoid the boiled taste and basically keep the original taste of fruits, and can high-quality apple jam be obtained.

The above description only involves several ones of the preferred embodiments and does not limit the present invention in any form. Any changes, equivalent changes and modifications made on the basis of the concept of the technical solution of the present invention shall fall within the scope of the technical solution of the present invention.

What is claimed is:

1. A preparation method of high-quality apple jam, comprising:
(1) selecting raw material and pre-treatment: selecting apples as raw material, washing the apples clean and cutting the apples into sections.
(2) crushing, pulping and steam enzyme deactivation integration: crushing and pulping the apples treated in step (1), wherein steam is sprayed to the apples during crushing and pulping, such that pulp temperature rises to 82-92° C. within 1-3 min; then the steam spraying is stopped, and the pulp temperature is kept at 82-92° C. for 42-12 s;
(3) ultra-fast cooling: quickly cooling the apple pulp obtained in step (2) by combining vacuum cooling and chilled brine conduction cooling, wherein the temperature quickly declines to below 40° C. within 2-3 min;
(4) post-treatment: filtering the apple pulp prepared in step (3) to remove kernels and then undergoes multi-effect concentration at a low temperature; formulating, canning, sterilizing and cooling the concentrated pulp, and then obtaining finished products.

2. The preparation method according to claim 1, wherein the raw material selected in step (1) are fresh and mature qualified apples without mould, decay, insect and peptide residue; a sugar degree of the apples is greater than 12 Brix; a bubbling cleaner is adopted to wash the apples; and each one of the apples is cut into 4-8 sections after washing.

3. The preparation method according to claim 1, wherein a predetermined time before crushing is carried out in step (2), inputting the steam in advance to exhaust air in a crushing cavity; homogeneously spraying the steam to the crushed apples; final temperature after temperature rise and the maintaining time of the final temperature follow a linear inverse relation: T=−t/3+96, wherein T represents the final temperature, in unit of ° C.; t represents the maintaining time, in unit of s.

4. The preparation method according to claim 1, wherein vitamin C or citric acid which accounts for 0.006-0.05% of mass of the apples, is added during crushing and pulping.

5. The preparation method according to claim 1, wherein a fast revolving blade tool is adopted in step (2) to crush the apples to about 2 mm.

6. The preparation method according to claim 1, wherein a pressure of the steam sprayed in step (2) is 0.15-0.30 MPa.

7. The preparation method according to claim 1, wherein in step (3), pumping the apple pulp obtained in step (2) into a vacuum cooler and then the pulp descends in a film state, wherein the vacuum cooler is a centrifugal scraper type film evaporator, and a jacket of the evaporator is filled with chilled brine.

8. The preparation method according to claim 7, wherein in step (3), a vacuum degree during vacuum cooling is 0.085-0.1 MPa, and temperature of the chilled brine in the jacket is less than −4° C.

9. The preparation method according to claim 1, wherein in step (4), concentrating the filtered apple pulp by using a film-descending type four-effect evaporator, wherein a first-effect temperature is 50-60° C.; a second-effect temperature is 42-50° C.; a third-effect temperature is 35-42° C.; a fourth-effect temperature is 25-35° C.; and a content of soluble solids in the apple pulp is 60-75 Brix after concentration.

10. The preparation method according to claim 1, wherein in step (4), carrying out the sterilization in a high-pressure sterilizing boiler; the sterilizing temperature in a center of the pulp reaches 90-98° C. and is kept at such temperature for 4-7 min; after being discharged from the boiler, spraying the pulp with cold water to be cooled to the normal temperature.
